(19) United States
(12) Patent Application Publication
(10) Pub. No.: US 2013/0064157 A1
(43) Pub. Date: Mar. 14, 2013

(54) ENERGY-SAVING BASE STATION IN A CELLULAR TELECOMMUNICATION NETWORK

(71) Applicant: TELEFONAKTIEBOLAGET L M ERICSSON (PUB, Stockholm (SE)

(72) Inventors: Stefan Lindgren, Vallda (SE); Sten Ingemar Sjöberg, Landvetter (SE)

(73) Assignee: TELEFONAKTIEBOLAGET L M ERICSSON (PUBL), Stockholm (SE)

(21) Appl. No.: 13/671,648

(22) Filed: Nov. 8, 2012

Related U.S. Application Data
(63) Continuation-in-part of application No. 12/676,401, filed on Mar. 4, 2010, now Pat. No. 8,331,276.

(51) Int. Cl. H04W 52/02

(52) U.S. Cl. 370/311

(57) ABSTRACT

An energy-saving base station in a telecommunication system. The base station includes a transceiver, a control processor, and a non-transitory computer-readable memory for storing an algorithm for controlling an energy-saving mode. The transceiver is configured to transmit a series of frame-structured signals in a cell served by the base station, each signal having a frame structure comprising a data region and an overhead part carrying at least synchronization or system information. In a normal mode, the signals are separated by a normal interval. When the base station enters the energy-saving mode, an interval between a first frame-structured signal and a next second frame-structured signal is increased from the normal interval to a longer energy-saving interval. The base station interrupts transmission of one or more third frame-structured signals during the energy-saving interval, and then includes the data regions of the interrupted signals in the frame of the second frame-structured signal.

### CROSS-REFERENCE TO RELATED APPLICATIONS

This application is a continuation-in-part of co-pending U.S. patent application Ser. No. 12/676,401 filed Mar. 4, 2010, which is a 371 of International Application No. PCT/SE2007/050620, filed Sep. 5, 2007, the disclosures of which are fully incorporated herein by reference.

### TECHNICAL FIELD

The present invention relates to cellular telecommunication systems. More particularly, and not by way of limitation, the present invention is directed to an energy-saving base station and apparatus and method for dynamic, distributed coordination of parameters between a plurality of cells in a cellular telecommunication network.

### BACKGROUND

Mobile communication is one of the most important technologies for contributing to social and economic development around the world. Optimizing energy efficiency will not only reduce environmental impact, it will also cut network costs which will give benefits for all using the mobile systems.

Modern standards as WCDMA, LTE and WiMAX have very high capacity in terms of users and throughput, which requires a large amount of energy. In order to achieve high data throughput in the cellular systems a dense cell plan has to be deployed. A base station consumes a considerable amount of energy, typically 65000 kWh per station per year.

Network design is a key issue improving the energy-efficiency. No amount of energy efficiency at the component level can make up for an inefficiently designed network. For instance the number of radio sites should be optimized for the coverage and quality that needs to be achieved.

In order to achieve an energy-efficient design a number of issues have to be addressed from start. At first, the true network needs has to be addressed. The exact coverage, capacity and quality have to be considered before getting into considerations about individual sites and equipment specifications. Moreover, the current and future business environment needs has to be considered, considering the possibility to rebuild or expand sites. Once these factors have been considered the operator should begin the network design process, looking into the total cost of the ownership and the alternative design options.

Capital expenditure typically represents a very small portion of the total cost of the ownership. Instead, the long-term savings from site reduction and efficient operation is significant, with a significant reduction in energy consumption as a key issue.

Optimizing solutions for reducing energy consumption means that every stone has to be turned over. Still, the total network solution is greater than the sum of their parts. This means that combining the best components in a package does not always give the best results. In the radio base station, the relative energy consumption of the different components vary on the dependency of the properties of the components it has to work with.

Typical sources of energy consumption in the base station are signal processing, RF conversion, power amplification, power supply, climate equipment (air conditioning), and the antenna feeder. For instance in traditional base stations, the equipment is located on the ground which means that the antennas has to be fed using several meters of cable. Half of the emitted power can be lost in the feeders. By placing the equipment in the top of the tower, a significant reduction in energy consumption is achieved. The equipment can be combined with a battery back-up unit that minimizes hardware and energy consumption.

Another way in which energy reduction can be achieved is through the use of standby modes. Base station sites are dimensioned to cope with peak hours. In a cell, a number of transceivers can run at the same time. Using energy management schemes, some transceivers can be put in standby instead of running in idling mode during low traffic hours.

Other ways of reducing the energy consumption include avoiding unnecessary DC/DC conversions and reducing the need for cooling fans and cooling systems. Modules based on digital power management can also reduce energy consumption.

There is an increasing need of delivering wireless technology with broadband capacity for cellular networks. A good broadband system must fulfill certain criteria, such as high data rate and capacity, low cost per bit, good Quality of Service, and greater coverage. High Speed Packet Access (HSPA) and Mobile WiMAX are examples two network access technologies that fulfill these criteria. Both of these technologies utilize a frame structure for the uplink and downlink communication between the base station and mobile terminals. In the following part of the background, the technology of WiMAX will be introduced as an example of a technology using frame structure, but other technologies such as WCDMA, GSM, HSPA, and Long Term Evolution (LTE) also use frame structuring. The frames of the different technologies differ to some extent.

WiMAX refers to the IEEE standard 802-16 where Mobile WiMAX relates to 802.16e-2005. Mobile WiMAX is an improvement of the modulation schemes used in earlier (fixed) WiMAX standards by the introduction of Scalable Orthogonal Frequency Division Multiple Access (SOFDMA) to carry data and supporting channel bandwidths with a large number of sub-carriers on different frequencies (sub-channels) within the band. The large number of sub-carriers improves the performance in multipath fading channels.

Scalable OFDMA is a statistical multiplexing technology, and scalable refers to the ability of the communication channel to be divided into a number of variable bit-rate digital channels (sub-carriers) or data streams. It means a dynamic scheduling wherein a time slot in the access assigned by the base station can enlarge and contract but still remain assigned to the particular mobile terminal. Different numbers of sub-carriers can be assigned to different users, and the Quality of Service, i.e. data rate and error probability, can be controlled individually for each user since the sub-channels are variable. The bandwidth of the channel can flex between 1.25 and 20 MHz. OFDMA (on which SOFDMA is based) has fixed sub-carrier bandwidth.

OFDMA is a multi-user version of Orthogonal Frequency Division Multiplexing (OFDM) modulation scheme. OFDM is for one single user in contrast to OFDMA. OFDM(A) uses a large number of sub-carriers, in which each sub-carrier is modulated for instance with Quadrature Amplitude Modulation (QAM). OFDM has the ability to cope with severe channel conditions, which makes Mobile WiMAX very robust. OFDM also has high spectral efficiency. OFDM may be viewed as using many slowly modulated narrowband signals rather than one rapidly modulated wideband signal. QAM will not be described any further in this document.

The duplex method of Mobile WiMAX is Time Division Duplex (TDD). TDD only occupies one single channel, with uplink and down link traffic assigned to different time slots. TDD with OFDMA provides subchannels and time slots enabling multi access for different users. TDD has an advantage in the case where the asymmetry of the uplink and downlink data speed is variable. As the amount of uplink data increases, more bandwidth can dynamically be allocated to that.

The ability of sub-channeling by OFDMA is shown in FIG. 1, which illustrates the frame structure schematically. The frame structure as visualized comprises a number of subchannels and a number of time slots, enabled by OFDMA being a statistical multiplexing technique. The data regions 11,12,13,14 of the different user devices 11,12,13,14 are illustrated in FIG. 1.

Mobile WiMAX transmitted via base stations uses SOFDMA with TDD. FIG. 2 shows a more detailed schematic view of a frame structure for OFDMA when operating in TDD mode. The frame (Frame N) comprises a downlink subframe 15, a following uplink subframe 16, a small guard interval 20 between the downlink and uplink subframe and an end interval 22 between the uplink and the downlink subframe of the next frame. In mobile WiMAX these frames are 5 ms long. Some WiMAX systems support OFDMA operating in Frequency Division Duplexing (FDD) in which the frame structure differs from TDD in that the uplink and downlink frames are transmitted at the same time over different carriers. TDD will in the future be used for most WiMAX deployments, since it allows for a more flexible sharing of bandwidth between up- and downlink, does not requires paired spectrum and has a reciprocal channel that can be exploited for spatial processing.

The downlink subframe 15 in TDD begins with overhead information for informing the user device about the characteristics of the system. The overhead comprises synchronization information 17 and system information 18. The overhead is followed by data regions 19 for the downlink data traffic in the downlink subframe. A guard interval 20 is followed by an uplink subframe 21 with data regions for the uplink data traffic from the different user devices. Finally there is the end interval 22 followed by the overhead synchronization information 17 of the next frame.

In WiMAX particularly the overhead begins with a downlink preamble that is used for physical-layer procedures (cell detection, time and frequency synchronization). The preamble is followed by a frame control header providing frame configuration and system information (modulation and coding maps) to find where and how to decode downlink and uplink signals. The frame control header and maps are sent for each available data region 19, 21.

Uplink and downlink subframes can instead of TDD be divided with Frequency Division Duplex. FDD is more efficient in the case of symmetric traffic. Another advantage is that it makes radio planning easier and more efficient. Compared with TDD, FDD divides the subframe by frequency instead, which means that the subframes are sent at the same time using different frequencies.

In order to achieve high data throughput in cellular systems, high order modulation, for example 64 QAM, and high transmit power is used at the base station. The physical resources in term of subcarriers and time are kept to a minimum to maximize the user data throughput. High performance power amplifiers are needed to keep the signal properties after the amplification. The linearity of the amplification is especially important. This requires a lot of power, which increases the energy consumption of the base station. Due to these requirements the amplifier efficiency is low and contributes to a large extent the base station energy consumption.

During low load or no load scenarios the base station still needs to transmit the system and synchronization information 17, 18 to serve the attached mobile terminals and so a new mobile terminal can access the system. The information has to be transmitted with enough power to reach all mobile terminals within the cell and is therefore transmitted with low modulation order and high output power. Due to these transmissions, the base station energy consumption is still quite significant.

### SUMMARY

In one embodiment, the present invention is directed to a base station in a telecommunication system for saving energy while enabling communication within a cell. The base station includes a transceiver, a control processor, and a computer-implemented algorithm embodied on a non-transitory computer readable medium. The transceiver is configured to transmit and receive in the cell, a signal with a frame structure, the frame structure comprising a downlink frame part and an uplink frame part. Each frame part carries at least one data region allocated to at least one user terminal or broadcasted for traffic flow between the telecommunication system and the user terminal via the base station. The downlink frame part includes an overhead part with at least synchronization or system information. The base station is configured to transmit the frame-structured signal periodically (Frame N, Frame N+1, Frame N+2, Frame N+3, wherein N is an integer) with a normal interval defined by the telecommunication system. When the processor executes the algorithm, the base station is caused to increase the interval between at least a first frame-structured signal and a next following second frame-structured signal to a energy-saving interval while in a energy-saving mode; enable the energy-saving mode by interrupting at least one third frame-structured signal; and include at least the data region or regions of the interrupted third frame-structured signal in the frame of the next signal transmitted.

In another embodiment, the present invention is directed to an energy-saving base station in a telecommunication system. The base station includes a transceiver, a control processor, and a non-transitory computer-readable memory coupled to the processor. The transceiver is configured to transmit a series of frame-structured signals in a cell served by the base station, each signal having a frame structure comprising a data region and an overhead part carrying at least synchronization or system information, wherein in a normal mode the signals are separated by a normal interval. The memory stores a computer-implemented algorithm for controlling an energy-saving mode. When the processor executes the algorithm, the base station is caused to increase an interval between a first frame-structured signal and a next second frame-structured signal from the normal interval to a longer energy-saving interval while the base station is in the energy-saving mode; interrupt transmission of one or more third frame-structured signals during the energy-saving interval; and include the data regions of the one or more interrupted third frame-structured signals in the frame of the second frame-structured signal.

In another embodiment, the present invention is directed to an energy-saving base station in a telecommunication system. The base station includes a transceiver, a control processor, and a non-transitory computer-readable memory coupled to the processor. The transceiver is configured to transmit a series of frame-structured signals in a cell served by the base station, each signal having a frame structure comprising a data region and an overhead part carrying at least synchronization or system information, wherein in a normal mode the signals are separated by a normal interval. The memory stores a computer-implemented algorithm for controlling an energy-saving mode. When the processor executes the algorithm, the base station is caused to transmit a first number of frame-structured signals with the normal interval to provide a mobile terminal sufficient time to decode the information in the overhead part; interrupt transmission of a second number of frame-structured signals following the transmitted signals for an energy-saving interval; and following the energy-saving interval, transmit the first number of subsequent frame-structured signals with the normal interval. The subsequent frame-structured signals include data regions of the subsequent frame-structured signals plus the data regions of the interrupted signals.

By introducing an energy-saving mode, the base station energy consumption is decreased with a base station configuration that can easily be introduced in present and upcoming standards.

### BRIEF DESCRIPTION OF THE DRAWINGS

In the following section, the invention will be described with reference to exemplary embodiments illustrated in the figures, in which:

FIG. 1 is a schematic view of an OFDMA frame structure;

FIG. 2 is a more detailed schematic view of the OFDMA frame structure when operating in TDD mode;

FIG. 3 illustrates a signal transmission from a base station in a low load situation with and without an energy-saving mode; and

FIG. 4 is a simplified block diagram of a base station in an exemplary embodiment of the present invention.

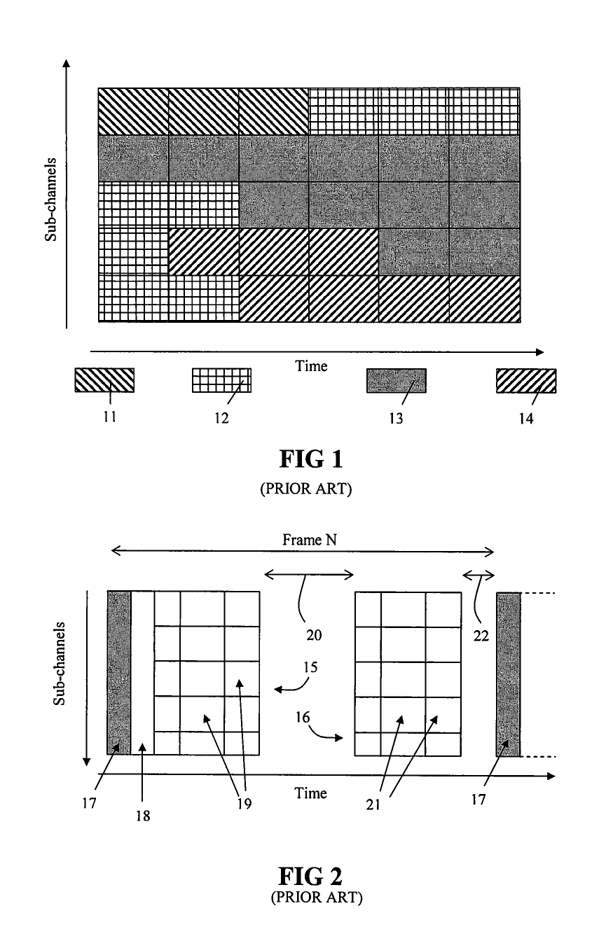

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Additionally, it should be understood that the invention may be implemented using software functioning in conjunction with a programmed microprocessor or general purpose computer, and/or using an application specific integrated circuit (ASIC). It will also be appreciated that while the current invention is primarily described in terms of methods and devices, the invention may also be embodied in a computer program product as well as a system comprising a computer processor coupled to a non-transitory memory encoded with one or more programs, wherein when the processor executes the programs, the processor causes a device or system to perform the functions described herein.

The embodiments refer to a telecommunication system, method, and node configured to save energy in a telecommunication system.

The telecommunication system comprises at least one base station for enabling communication within a cell. The base station communicates with a mobile user terminal, such as a hand-held phone. In the telecommunication system, the base station enables the communication between one or more mobile telephones within a cell (a cell is a geographic area covered by the base station) and the base station.

A signal 23 having a frame structure is transmitted and received in the cell by the base station, the structure of the frame comprising a downlink frame part 15 and an uplink frame part 16.

The embodiment shown in FIG. 2, which relates to TDD, comprises a frame part 15 in form of a subframe followed by a frame part 16 also in form of a subframe. The frame structure in TDD is divided into a downlink subframe a following uplink subframe, a small guard interval 20 between the downlink and uplink subframe and an end interval 22 between the uplink and the downlink subframe of the next frame. It should however be understood by the person skilled in the art that the feature “frame part” as disclosed in the claims also includes embodiments with FDD, in which the frame parts are divided by frequency instead, or other technologies for duplex.

Each frame part has the ability of carrying at least one data region allocated to at least one user or broadcasted for the traffic flow between the telecommunication network and the user terminal via the base station. The fact that the allocated to at least one user or broadcasted means that the invention includes both unicast traffic flow between the system and one user terminal, multicast between the system and a group of user terminals and broadcast between the system and every user terminal within a broadcast domain.

The downlink frame part 15 comprises an overhead part 17, 18 with at least synchronization or system information. Often both information types 17, 18 are included but there is an option that only one of these types is included in the overhead. Still, at least one of the synchronization or system information has to be transmitted. Consequently, the term “or” will be used.

As described in connection with FIG. 2 the downlink frame part 15 begins with overhead information for informing the user device about the characteristics of the system. The overhead comprises at least synchronization information 17 or system information 18. The synchronization information is used for time and frequency synchronization between the base station and the user terminal.

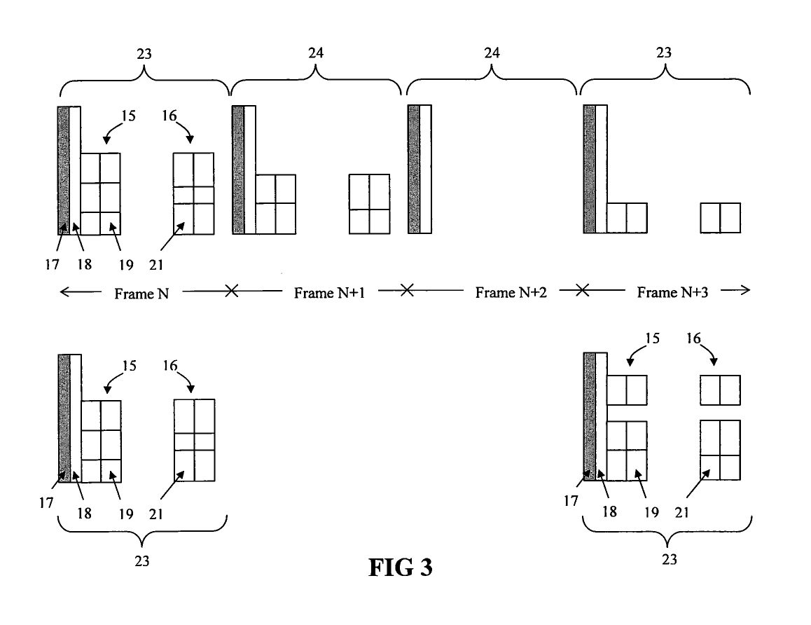

The system information contains modulation and coding scheme and maps which enables frame configuration between the base station and the user terminal. The overhead is followed by the data regions 19 for the downlink data traffic in the downlink frame part 15, the uplink frame part 16 with data regions 21 for the uplink data traffic from the different user terminals. As illustrated in FIG. 3 the data regions 19, 21 may vary in size from one signal to the next, which is enabled for instance with OFDMA.

FIG. 3 illustrates the fact that the frame-structured signal 23, 24 is transmitted periodically with a normal interval defined by the system. A normal interval in OFDMA is 5 ms. As shown there is a frame Frame N followed by frames Frame N+1, Frame N+2, Frame N+3 and so forth.

The embodiment shown in FIG. 3, which also relates to TDD, comprises a frame part 15 in the form of a subframe followed by a frame part 16 also in form of a subframe. It should however be understood by the person skilled in the art that the feature “frame part” also includes embodiments with FDD, in which the frame parts are divided by frequency instead, or other technologies for duplex. In FDD, this means that the frame parts can instead be transmitted at the same time.

The signal 23, 24 has to be transmitted periodically even if no data regions 19, 21 are included. During low load or no load scenarios the base station still needs to transmit at least the system or synchronization information 17, 18 to serve the attached mobile terminals and so a new mobile terminal can access the system. The information has to be transmitted with enough power to reach all mobile terminals within the cell and is therefore transmitted with low modulation order and high output power. Due to these transmissions the base station energy consumption is still quite significant.

An object of the present invention is to increase the energy efficiency in a base station with a frame-structure technology. In an energy-saving mode, the system increases the interval between at least a first 23 and the next following second frame-structured signal 23 to an energy-saving interval. The second signal (see FIG. 3, lower part) is the next signal, which follows immediately after the first signal. The overhead part is contained in each transmitted signal and by increasing the interval to the energy-saving interval, energy savings is achieved.

The energy-saving interval is enabled by interrupting at least a third frame-structured signal 24. This means that in order to save energy at least one frame-structured signal, named the third signal, is interrupted. As an example the system may transmit three signals 23 and thereafter interrupt ten signals 24. The three signals in one row gives the user terminal time to decode the information in the overhead part 17, 18, such as UL map data, and process the information to be sent in the UL frame part 21.

The energy-saving interval is optionally enabled by interrupting the frame-structured signal 24 periodically. The frame-structured signal is further optionally interrupted by interrupting the overhead part 17, 18. For instance at least every second signal is interrupted. This is shown in FIG. 3 in the lower part where the interval is increased 3 times by interrupting two signals Frame N+1 and Frame N+2. Since the overhead part of Frame N+1 and Frame N+2 is normally transmitted with enough power to reach all mobiles within the cell, such an interruption will save a significant amount of energy.

The fact is also that the interrupted signals contains overhead parts 17,18 which do not have to be sent later. Instead only the data region or regions 19,21 of the interrupted signal are included in the frame of the next signal transmitted. This is shown in the signal 23 in Frame N+3 (see lower part of the figure) where the data regions from Frame N+1 and Frame N+3 (see upper part of the figure) are included in the signal.

The energy-saving mode is activated by the system at certain operating conditions such as the level of usage for the cell capacity, the number of user terminals in the cell, and/or statistics of cell usage over time. The system is monitored continuously, and if the traffic load goes down for a period of time, the energy-saving mode may be activated. Statistics of traffic load over time are also very useful. For example, an operator may monitor a low traffic load in a certain cell at night between midnight and 06.00 in the morning. The operator may then via a management system modify the operation of this base station so that the energy-saving mode is activated every night between midnight and 06.00. The system may also be modified so that if the traffic load is below a certain level the energy-saving mode is activated. In this example, the operator decides which quality of service will be provided at certain conditions.

It is vital that the user terminal is aware of the energy-saving mode. Therefore, the overhead part of the transmitted frame-structured signals during the energy-saving mode comprises information about the energy-saving mode and its properties such as the energy-saving interval. The energy-saving interval may be given, for example, in a management message such as a downlink channel descriptor or as a value or a code in the map in each transmitted frame.

The overhead part of the frame-structure signal is transmitted with enough power to reach all user terminals within the cell wherein the data region or regions are transmitted.

The energy-saving mode may be controlled by an algorithm which is loaded into the system in order to enable the method for energy saving.

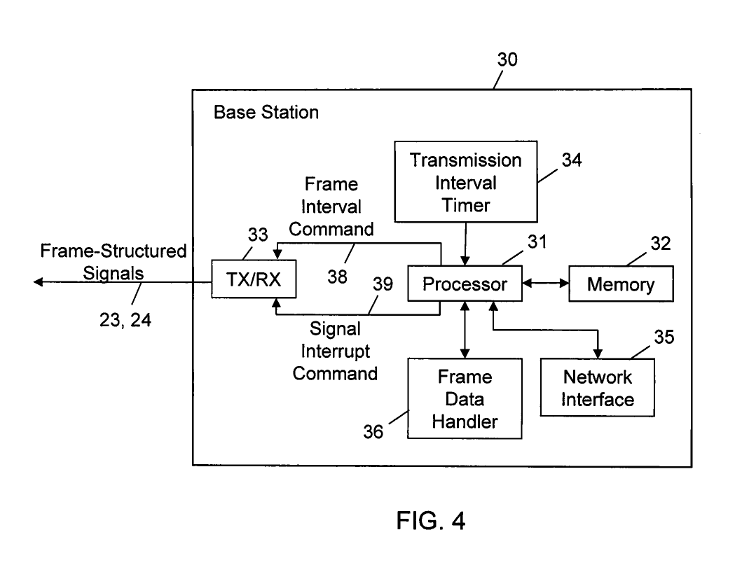

FIG. 4 is a simplified block diagram of a base station 30 in an exemplary embodiment of the present invention. The base station may be controlled, for example, by a processor 31 executing computer program instructions stored in a non-transitory memory 32 coupled to the processor. The processor controls a transceiver (TX/RX) 33 to transmit frame-structured signals 23, 24 with an interval as measured by a transmission interval timer 34. Data for the frame-structured signals may be received over a network interface 35, and may be apportioned to the different frames as described above by a frame data handler 36.

The base station 30 transmits and receives the frame-structured signals in an associated cell periodically with a normal interval defined by the telecommunication system when the base station is not in the energy-saving mode. The frame structure (for example, Frame N, Frame N+1, Frame N+2, Frame N+3) comprises a downlink frame part 15 and an uplink frame part 16. Each frame part has the ability to carry at least one data region 19, 21 allocated to at least one user or broadcasted for the traffic flow between the telecommunication network and the user terminal via the base station. The downlink frame part 16 includes an overhead part 17, 18 with at least synchronization or system information.

When the base station enters the energy-saving mode, the base station increases the interval between at least a first frame-structured signal and the next following second frame-structured signal. The interval, as measured by the transmission interval timer 34, may be determined by an algorithm, which controls the energy-saving mode when executed by the processor 31.

The technology of the base station may be, for example, WiMAX, LTE, UMTS or GSM, which are all protocols operating with frames/frame structures. Consequently, every protocol having frames as an overhead consuming a large amount of energy is relevant in relation to the present invention. As an option, the base station operates with OFDMA for enabling multiple accesses. The base station may use a higher order modulation scheme such as 64 QAM.

A possible variant is to just use the extended energy-saving interval for base station downlink transmissions and scheduled uplink transmissions but keep a standing allocation for random access attempts to reduce the latency while in the energy-saving mode.

It will also be appreciated by the person skilled in the art that various modifications may be made to the above-described embodiments without departing from the scope of the present invention. Accordingly, the scope of patented subject matter should not be limited to any of the specific exemplary teachings discussed above, but is instead defined by the following claims.

What is claimed is:

1. A base station in a telecommunication system for saving energy while enabling communication within a cell, the base station comprising:
a transceiver configured to transmit and receive in the cell, a signal with a frame structure, the frame structure comprising a downlink frame part and an uplink frame part, each frame part carrying at least one data region allocated to at least one user terminal or broadcasted for traffic flow between the telecommunication system and the user terminal via the base station, the downlink frame part having an overhead part with at least synchronization or system information, wherein the base station is configured to transmit the frame-structured signal periodically (Frame N, Frame N+1, Frame N+2, Frame N+3, wherein N is an integer) with a normal interval defined by the telecommunication system;
a control processor; and
a computer-implemented algorithm embodied on a non-transitory computer readable medium, wherein when the processor executes the algorithm, the base station is caused to:
increase the interval between at least a first frame-structured signal and a next following second frame-structured signal to a energy-saving interval while in a energy-saving mode;
enable the energy-saving mode by interrupting at least one third frame-structured signal; and
include at least the data region or regions of the interrupted third frame-structured signal in the frame of the next signal transmitted.

2. The base station according to claim 1, wherein the base station is configured to operate according to a standards specification selected from the group consisting of WiMAX, Long Term Evolution (LTE), Universal Mobile Telecommunications System (UMTS), and Global System for Mobile Communications (GSM).

3. The base station according to claim 1, wherein the base station is configured to enable multiple accesses using orthogonal frequency division multiple access (OFDMA).

4. An energy-saving base station in a telecommunication system, the base station comprising:
a transceiver configured to transmit a series of frame-structured signals in a cell served by the base station, each signal having a frame structure comprising a data region and an overhead part carrying at least synchronization or system information, wherein in a normal mode the signals are separated by a normal interval;
a control processor; and
a non-transitory computer-readable memory coupled to the processor, the memory storing a computer-implemented algorithm for controlling an energy-saving mode, wherein when the processor executes the algorithm, the base station is caused to:
increase an interval between a first frame-structured signal and a next second frame-structured signal from the normal interval to a longer energy-saving interval while the base station is in the energy-saving mode;
interrupt transmission of one or more third frame-structured signals during the energy-saving interval; and
include the data regions of the one or more interrupted third frame-structured signals in the frame of the second frame-structured signal.

5. The base station according to claim 4, wherein the base station is configured to periodically interrupt transmission of every third frame-structured signal.

6. An energy-saving base station in a telecommunication system, the base station comprising:
a transceiver configured to transmit a series of frame-structured signals in a cell served by the base station, each signal having a frame structure comprising a data region and an overhead part carrying at least synchronization or system information, wherein in a normal mode the signals are separated by a normal interval;
a control processor; and
a non-transitory computer-readable memory coupled to the processor, the memory storing a computer-implemented algorithm for controlling an energy-saving mode, wherein when the processor executes the algorithm, the base station is caused to:
transmit a first number of frame-structured signals with the normal interval to provide a mobile terminal sufficient time to decode the information in the overhead part;
interrupt transmission of a second number of frame-structured signals following the transmitted signals for an energy-saving interval; and
following the energy-saving interval, transmit the first number of subsequent frame-structured signals with the normal interval, wherein the subsequent frame-structured signals include data regions of the subsequent frame-structured signals plus the data regions of the interrupted signals.

7. The base station according to claim 6, wherein the first number of frame-structured signals is three.

8. The base station according to claim 7, wherein the second number of frame-structured signals is ten.

9. The base station according to claim 6, wherein the overhead part of the interrupted frame-structured signals is never transmitted.

10. The base station according to claim 6, wherein the base station is configured to activate the power saving mode upon detecting defined operating conditions selected from a group consisting of:
a level of usage for cell capacity;
the number of user terminals in the cell; and
statistics of cell usage over time.

11. The base station according to claim 6, wherein the base station is configured to include in the overhead part of each transmitted frame-structured signal while in the energy-saving mode, information about the energy-saving mode and the energy-saving interval.

12. The method according to claim 6, wherein the overhead part of each transmitted frame-structured signal is transmitted with enough power to reach all user terminals within the cell.
